(19) United States
(12) Patent Application Publication
(10) Pub. No.: US 2015/0363888 A1
(43) Pub. Date: Dec. 17, 2015

(54) FINANCIAL STATEMENT FORECASTER

(71) Applicant: BANK OF AMERICA CORPORATION, Charlotte, NC (US)

(72) Inventors: Amit Chopra, Rohini (IN); Shane Prakash Masih, Dehradun (IN); Ashu Chugh, Faridabad (IN); Prashant Bidkar, Shakarpur (IN); Mitasha Navani, Nehru Nagar (IN)

(21) Appl. No.: 14/305,716

(22) Filed: Jun. 16, 2014

(51) Int. Cl. G06Q 40/00

(52) U.S. Cl. CPC G06Q 40/12

(57) ABSTRACT

Embodiments of the invention are directed to systems, methods and computer program products for use in financial forecast systems, where historical financial data is analyzed for purposes of providing projected financial statements. An exemplary apparatus is configured to receive financial data, from a predetermined period of time in the past that is associated with a business entity requesting to receive projected financial statements, analyze the financial data from the predetermined period of time in the past, and determine based on the analysis a financial forecast for the entity for a predetermined period of time in the future, and provide one or more projected financial statements for the predetermined time period in the future based at least partially on the financial forecast of the entity.

### BACKGROUND

In today's age, financial forecast typically refer to assessments and/or estimates of the forthcoming financial outcome of a particular company over a given period of time such as one year. The estimates may be generally based upon historical financial data (e.g. internal account and sales data) as well as external data related to the market and/or other economic indicators. It is known in the art that certain aspects of financial forecast, such as forecasted revenues, are difficult to predict. A need exist for a means to ease the burden associated with financial forecast and provide accurate forecasted financial statements for businesses and various other entities.

### BRIEF SUMMARY

Embodiments of the invention are directed to systems, methods, and computer program products for use in financial forecast systems and analyzing historical financial data for purposes of providing projected financial statements. An exemplary apparatus for use in financial forecast systems, whereby the apparatus analyzes historical financial data for purposes of providing projected financial statements, may comprise a memory, a computing processor, and a module stored in the memory, said module comprising instruction code executable by one or more computing processors, and configured to cause the one or more computing processors to receive financial data that is associated with a business entity requesting to receive projected financial statements, wherein the financial data is received from a predetermined period of time in the past, analyze the financial data from the predetermined period of time in the past, determine a financial forecast for the business entity for a predetermined period of time in the future, wherein the financial forecast is based at least partially on the analysis of the from the predetermined period of time in the past, and provide one or more projected financial statements for the predetermined time period in the future based at least partially on the financial forecast of the business entity.

In some embodiments the module is further configured to cause one or more computer processors to receive a request from the business entity that identifies the business entity is requesting to receive a projected financial statement, and transmit the request to a third party entity such that the financial data associated with the business entity is received from a database maintained by the third party entity.

In some embodiments, the financial data is automatically retrieved, from at least one database associated with the business entity, in response to receiving a request from the business entity to provide at least one projected financial statement.

In some embodiments, the financial data is manually inputted by a user associated with the business entity requesting to receive at least one projected financial statements, and wherein the module is further configured to cause one or more computer processors to prompt the user to manually enter the financial data in response to receiving a request from the business entity to provide projected financial statements.

In some embodiments, the financial data is received on a semi-continuous basis and periodically stored such that it is retrievable for analysis at a later time.

In some embodiments, the module is further configured to cause one or more computer processors to determine the accuracy of a projected financial statement based at least partially upon the accuracy at least one previously projected financial statement.

In some embodiments, the module comprises a customized tool for receiving and projecting financial data having one or more buttons that trigger the calculation of a plurality of values.

In some embodiments, the module is further configured to cause one or more computer processors to provide a high level projected financial statement for a time period that exceeds the predetermined period of time in the future.

In some embodiments, the module is further configured to cause one or more computer processors to determine one or more trends within the financial data for the predetermined period of time in the past.

In some embodiments, the module is further configured to cause one or more computer processors to determine that a portion of the received information is useful for analysis in providing a projected financial statement, and extract the portion of information for analysis.

In some embodiments, the module is further configured to cause one or more computer processors to determine whether or not an adequate amount of information has been received to conduct an analysis that will yield and accurate projected financial statement, and request that a user input additional information based at least partially on determining that an adequate amount of information has not been received.

In some embodiments, the module is further configured to cause one or more computer processors to receive general financial data associated with the business industry that the business entity is a part of.

In some embodiments, the module is further configured to cause one or more computer processors to determine the type of business industry that the business entity is a part of based on at least one of a user input, an analysis of the received information associated with the business entity, or a searching method.

In some embodiments, the module is further configured to cause one or more computer processors to receive, from a user, a code or identifier that indicates an industry type associated with the business entity.

In some embodiments, the module is further configured to determine a projection scenario for use in providing a projected financial statement, wherein the projection scenario is used during the analysis of the financial data.

In some embodiments, the projection scenario is determined in response to a user input, wherein a user selects the projection scenario from within a drop down menu that list one or more selectable projection variables.

In some embodiments, the module is further configured to cause one or more computer processors to receive, within the financial data, one or more primary financial data parameters having a numeric value, and calculate a secondary financial data parameter having a numeric value for use in providing the projected financial statement.

An exemplary method for use in financial forecast systems, whereby the method analyzes historical financial data for purposes of providing projected financial statements, may comprise one or more steps including but not limited to receiving financial data that is associated with an entity requesting to receive projected financial statements, wherein the financial data is received from a predetermined period of time in the past, analyzing the financial data from the predetermined period of time in the past, determining a financial forecast for the entity for a predetermined period of time in the future, wherein the financial forecast is based at least partially on the analysis of the from the predetermined period of time in the past, and providing one or more projected financial statements for the predetermined time period in the future based at least partially on the financial forecast of the entity.

In some embodiments, the method may further comprise receiving, within the financial data, one or more primary financial data parameters having a numeric value, and calculating a secondary financial data parameter having a numeric value for use in providing the projected financial statement.

An exemplary computer program product for use in financial forecast systems, whereby the computer program product analyzes historical financial data for purposes of providing projected financial statements, may comprise a non-transitory computer-readable medium comprising a set of codes for causing a computer to receive financial data that is associated with an entity requesting to receive projected financial statements, wherein the financial data is received from a predetermined period of time in the past, analyze the financial data from the predetermined period of time in the past, determine a financial forecast for the entity for a predetermined period of time in the future, wherein the financial forecast is based at least partially on the analysis of the from the predetermined period of time in the past, and provide one or more projected financial statements for the predetermined time period in the future based at least partially on the financial forecast of the entity.

In some embodiments, the computer program product may further comprise a set of codes for causing a computer to receive, within the financial data, one or more primary financial data parameters having a numeric value, and calculate a secondary financial data parameter having a numeric value for use in providing the projected financial statement.

### BRIEF DESCRIPTION OF THE DRAWINGS

Having thus described embodiments of the invention in general terms, reference will now be made to the accompanying drawings, where:

FIG. 1 is a high level process flow for providing forecasted financial statements, in accordance with embodiments of the present invention;

FIG. 2 is a screenshot illustrating a customizable tool for providing forecasted financial statements, in accordance with embodiments of the present invention;

FIG. 3 is a screenshot illustrating a customizable tool for providing forecasted financial statements, in accordance with embodiments of the present invention;

FIG. 4 is a screenshot illustrating a customizable tool for providing forecasted financial statements, in accordance with embodiments of the present invention;

FIG. 5 is a screenshot illustrating a customizable tool for providing forecasted financial statements, in accordance with embodiments of the present invention;

FIG. 6 is a screenshot illustrating a customizable tool for providing forecasted financial statements, in accordance with embodiments of the present invention;

FIG. 7 is a screenshot illustrating a customizable tool for providing forecasted financial statements, in accordance with embodiments of the present invention; and

FIG. 8 is a screenshot illustrating a forecasted financial statement, in accordance with embodiments of the present invention.

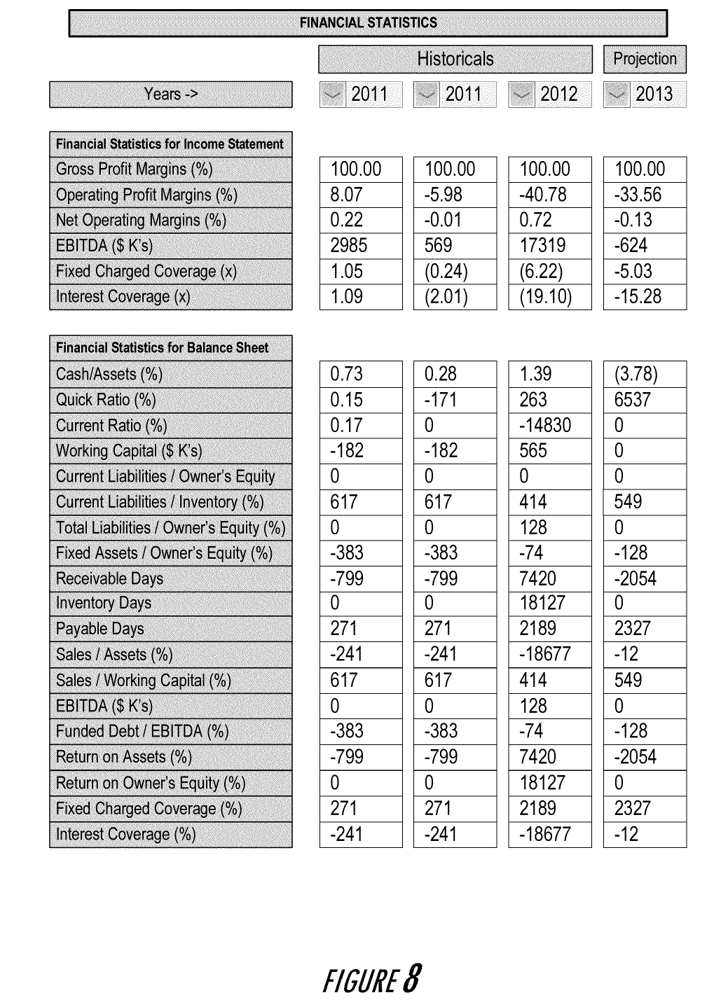

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for use in financial forecast systems, where historical financial data is analyzed for purposes of providing projected financial statements. The invention enables a system to receive historical financial data and project future financial outcomes for a business entity based at least partially on an analysis of the historical financial data for the business entity.

In some embodiments, an “entity” may be a business entity that is a part of a particular business industry and is requesting to receive a projected and/or forecasted financial statement. An entity may additionally be a third party entity such as financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity.

In some embodiments, the “user” may be a system user that is associated with either the system provider, the business entity, an associated business industry, a third party entity or the like.

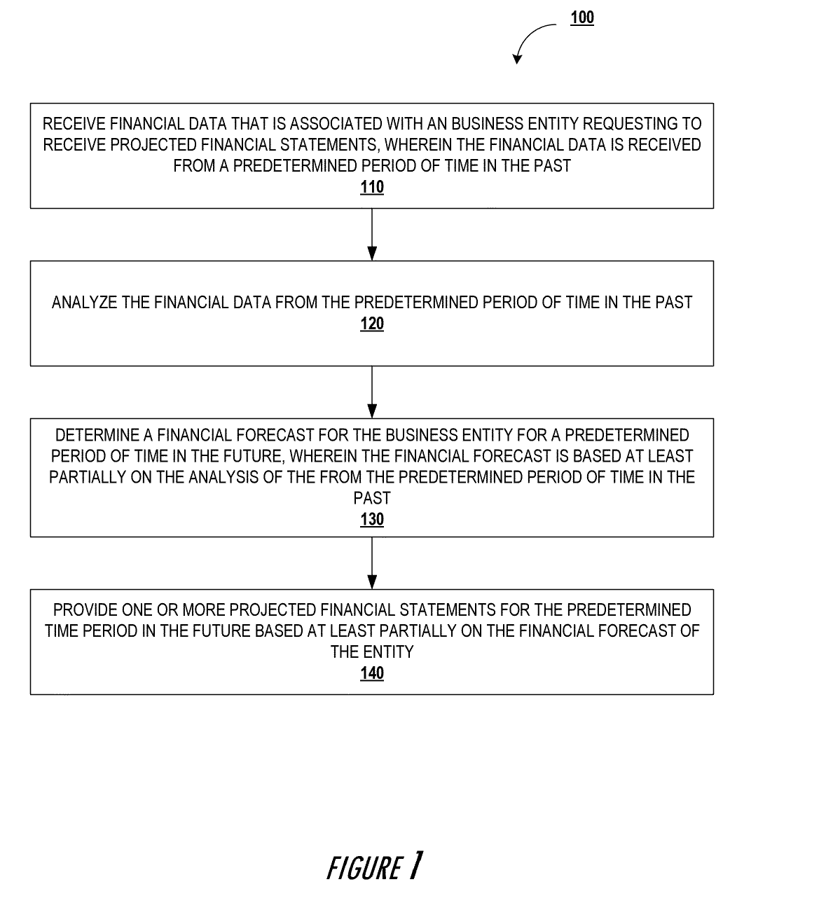

Referring now to FIG. 1, a high level process flow for providing forecasted financial statements 100 is illustrated in accordance with one embodiment of the present invention, which will be discussed in further detail throughout this specification. As illustrated, the method may comprise a plurality of steps, including but not limited to, receiving financial data that is associated with an entity requesting to receive projected and/or forecasted financial statements 110, analyzing the received financial data for a predetermined period of time in the past 120, based at least partially on the analysis determining a financial forecast for the entity for a predetermined period of time in the future 130, and based at least partially on the financial forecast providing one or more projected financial statements for the predetermined period of time in the future 140.

In some embodiments, the financial data is received through an automated input from a database or server associated with the entity requesting to receive projected financial statement. For example, in one embodiment, the financial data is received and/or retrieved from a public database that is maintained by a third party entity responsible for licensing information on businesses and corporations for use in credit decisions, business-to-business marketing and supply chain management. As such the system may be further configured to receive a request from the business entity that identifies the business entity is requesting to receive a projected financial statement, and the system may transmit the request to the third party entity such that financial data associated with the business entity is received by the system from a database maintained by the third party entity. In another embodiment, where the financial data is not specific to the business entity itself but generally directed towards the industry associated with the business entity, the financial data and/or industry information may be received or retrieved from a database associated with one or more market research organizations, business research organizations, and the like.

In one embodiment, where the business entity is a publicly traded company, the financial data may be received and/or retrieved from financial data that has been uploaded to or stored in a database associated with the Securities and Exchange Commission. As such the system may be further configured to receive a request from the business entity that identifies the business entity is requesting to receive a projected financial statement, and transmit the request to the Securities and Exchange Commission such that the financial data associated with the business entity is automatically received by the system from a database maintained by the Securities and Exchange Commission. It should be noted that as used herein receiving information from a database may refer to receiving information that is stored in a database and/or presented on one or more websites associated with the database. To this extent, the system may be alternatively configured to manually retrieve information from databases/websites using other means such as screen scraping and/or one or more additional search techniques.

In some embodiments, the financial data is received through manual input from a user or third party associated with the entity requesting to receive projected financial statement. For example, in an embodiment, where the business entity is a private company, the financial data may be received directly from the business entity requesting to receive projected financial statements. As such the system may be further configured to provide a user interface that allows a system user or an individual associated with the business entity to manually input financial data related to the business entity such that the financial data is subsequently received by the system. In one embodiment, the user interface is a non-specific form that receives general financial data. The user inputting the data may determine the type of information that he/she wishes to input into the system. The system may then determine which portion of the received information will be useful for analysis in providing a projected financial statement, and extract that portion of information for later analysis. In another embodiment, the user interface is an information-specific form that receives targeted financial data for use in providing projected financial statements. The information-specific form may outline the type of information that should be inputted and is deemed necessary for providing a projected financial statement. In such an embodiment, the user may or may not be able to completely fill the required information specified in the form. The system may then determine whether or not an adequate amount of information has been provided to conduct an analysis that will yield and accurate financial projection. If it is determined that an adequate amount of information has been provided the system may proceed with an analysis of the received data, if it is determined that an adequate amount of information has not been provided the system may request that a user input additional information, specifically that the user input the missing components within the fillable form, prior to proceeding with an analysis of the received data. In alternate embodiments, the system may proceed with an analysis of the received financial data without first determining whether or not an adequate amount of information has been provided to conduct an analysis that will yield and accurate financial projection.

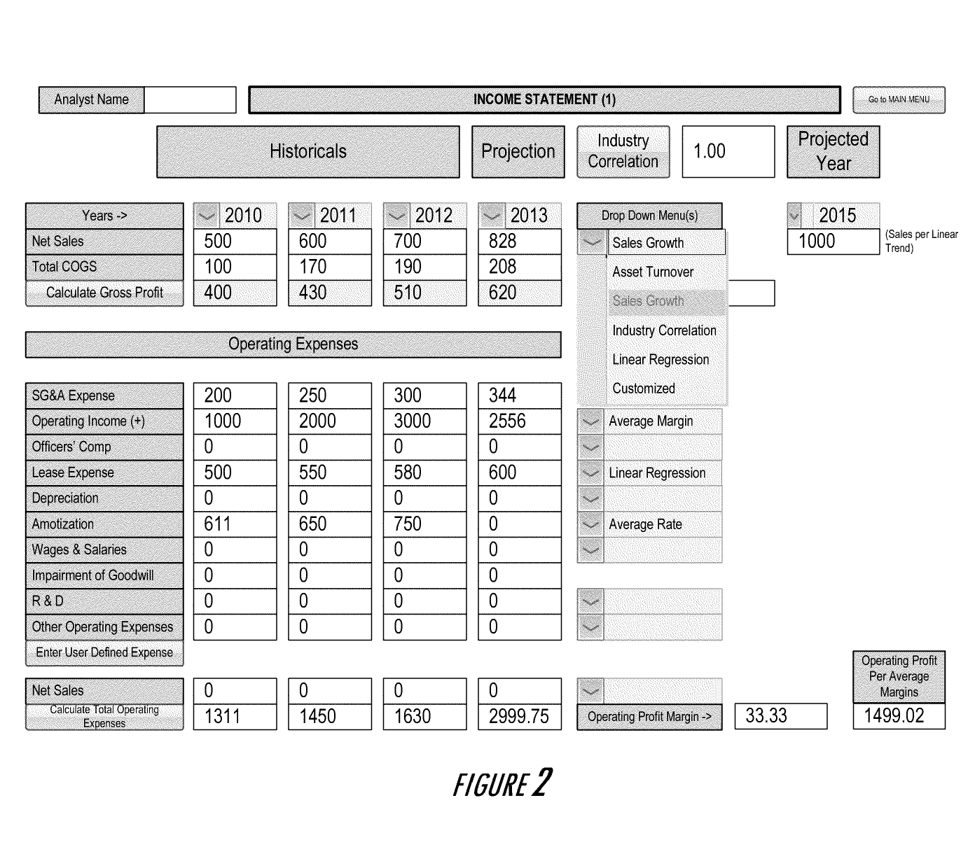

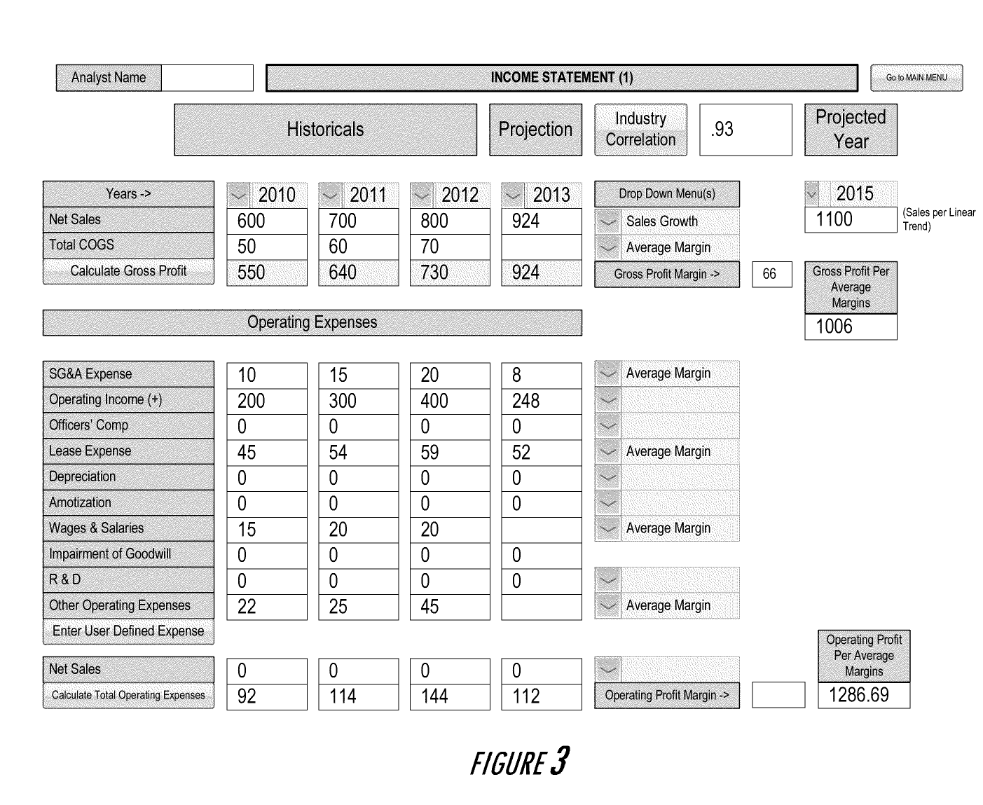

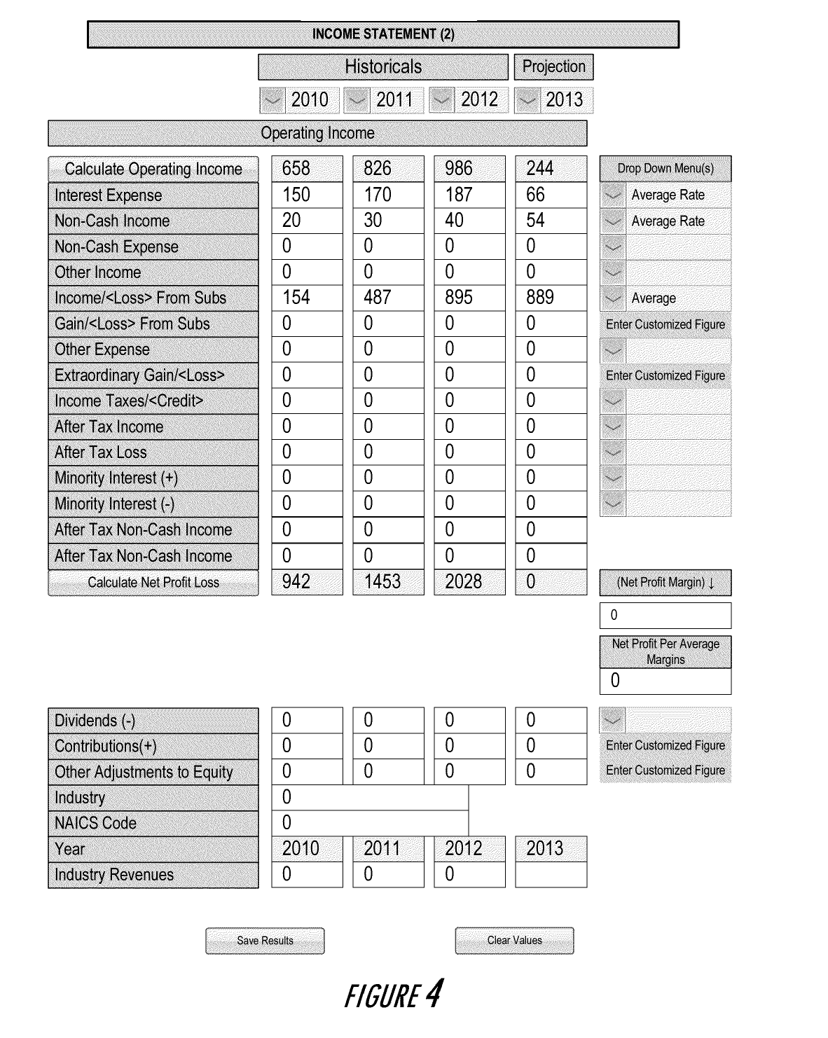

In some embodiments, data is continuously received or retrieved on a recurring basis and subsequently stored and/or configured to be retrievable for analysis at a later time. For example, the financial data may be retrieved on a quarterly basis for a particular business entity and stored in a database associated with the business entity or a third party that is configured to be later accessible for analysis. Data may be aggregated and/or categorized based upon one or more time periods, as shown in at least FIG. 2 through FIG. 6. For example, the data may be received in a composite format and later aggregated based on calendar years. In an alternative embodiment, the data is received in an aggregated format for each period of time presented prior to being received.

In a preferred embodiment, receiving financial data associated with the business entity further comprises receiving financial data that is not specifically associated with the business entity itself but generally related to the industry that the entity is a part of. It should be noted that financial data related to the business industry that the entity is a part of may be received using any methods discussed herein for receiving financial data related to a business entity. In some embodiments, the system must first determine the industry type prior to retrieving financial data related to the business industry. In such an embodiment, the business industry type may be determined based on a user input, an analysis of the financial data and/or general information associated with the business entity, one or more searching methods, a combination of the aforementioned, and/or various other methods. After the industry type has been determined the system may retrieve the financial data from one or more databases associated with industry classification systems, market research organization, the business entity, financial institutions, third party data providers and/or the like. In an embodiment where the industry type is determined based on user input the customized tool or spreadsheet for receiving and projecting financial data may be further configured to receive, from a user, a code (e.g. NAICS code) or identifier that indicates the industry type. The business industry related data may be imported directly into the customized tool or spreadsheet for receiving and projecting financial data and/or save on a back end server/database for use in later comparisons or analysis.

The system may first receive historical financial data that is generally related to a predetermined period of time in the past. As discussed in exemplary embodiments herein, the predetermined time period is a three (3) year period of time that may refer to either three (3) calendar years or three (3) fiscal years. However, it should be noted that in other embodiments the predetermined period may be defined by any period of time including, but not limited to, a predetermined number of years, months, days, and the like. As discussed herein predetermined parameters may be defined by the business entity, the industry associated with the business entity, the system provider, a third party entity or the like. The received financial data may be related to a plurality of financial parameters that can be obtained and/or generated for any type of business industry. The financial data parameters may be related to financial parameters typically associated with income statements, balance sheets, cash flow statements and the like, where each parameter may be presented as an individual line item within a customized tool or spreadsheet for receiving and projecting financial data.

As shown in FIG. 2 through FIG. 4, the financial data parameters received and projected for an income statement may include, but not be limited to, parameters such as profits (e.g. net sales amount, total cost of goods sold (COGS)), gross profit, operating expenses (e.g. selling, general and administrative expense (SG & A Expense), operating income (+), officers' compensation, lease expense, depreciation, amortization, wages & salaries, impairment of goodwill, research & development, and/or a user defined parameter), total operating expenses, general profits/losses (e.g. operating income, interest income, interest expense, non-cash income, non-cash expense, other income, income/loss from subsidiary, gain/loss on assets, other expenses, extraordinary gain/loss, income taxes/credit, after tax income, after tax loss, minority interest (+/−)), net profit/loss, dividends (−), contributions (+), other adjustment to equity, industry type, North American Industry Classification System code(s) (NAICS), industry revenues, and financial statistics (e.g. gross profit margins (%); operating profit margins (%); net operating margins (%); earnings before interest, taxes, depreciation, and amortization (EBITDA); fixed charged coverage, and interest coverage), and the like which may be described in further detail throughout the specification.

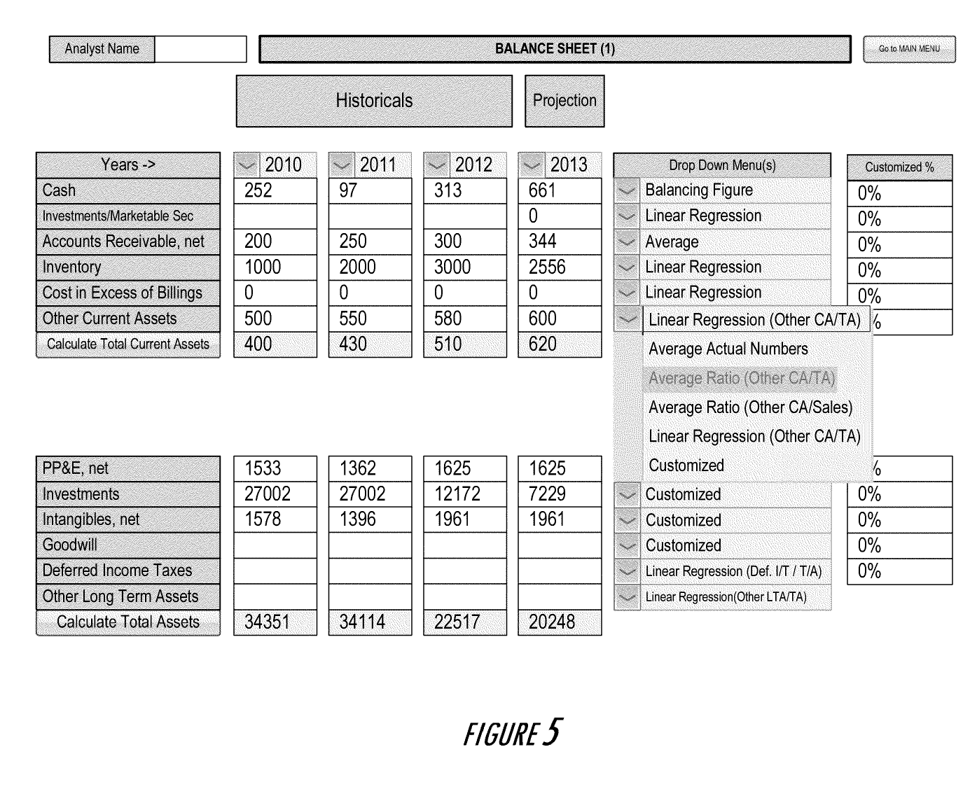

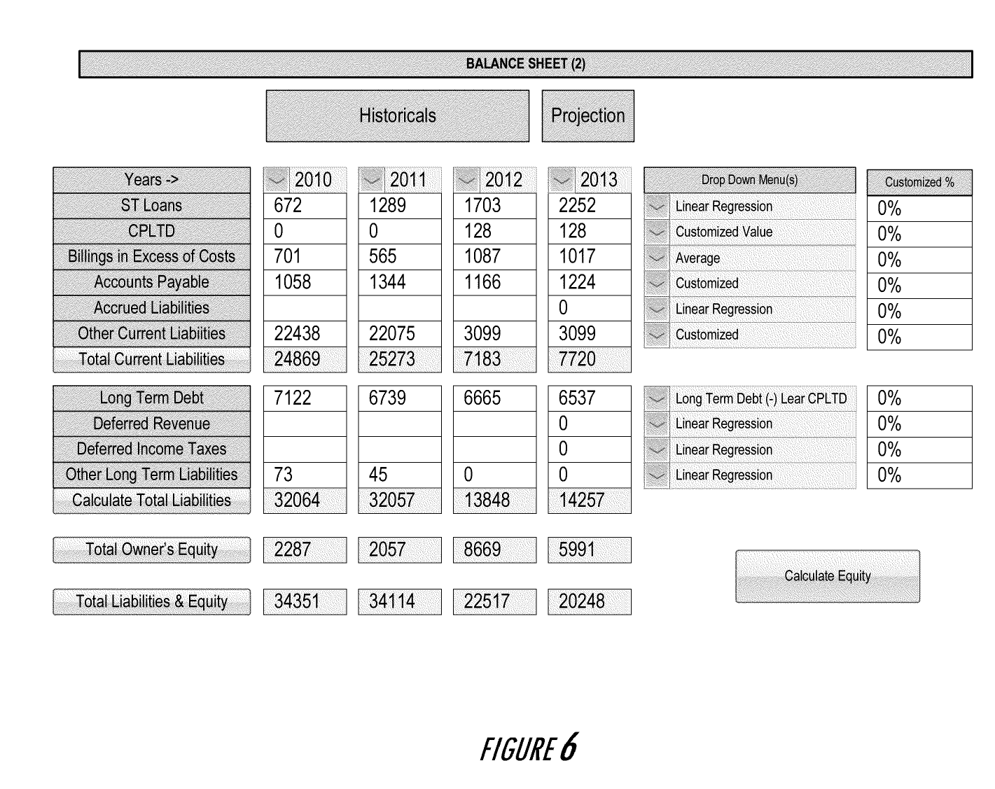

As shown in FIG. 5 and FIG. 6, the financial data parameters received and projected for a balance sheet may include, but not be limited to, current assets (e.g. cash, investments/marketable securities, accounts receivable (net), inventory, costs in excess of billings, other current assets), total current assets, assets (e.g. property, plant and equipment (PP&E) (net), investments, intangibles (net), goodwill, deferred income taxes, other long term taxes), total assets, current liabilities (e.g. loans, current portion of long-term debt (CPLTD), billings in excess of cost, accounts payable, accrued liabilities, other current liabilities), total current liabilities, liabilities (e.g. long term debt, deferred revenue, deferred income taxes, other long term liabilities), total liabilities, total owner's equity, total liabilities and equity, and financial statistics (e.g. cash/assets (%), quick ratio, current ration, working capital, current liabilities/owner's equity, current liabilities/inventory, total liabilities/owner's equity, fixed assets/owner's equity, receivable days, inventory days, and the like which may be described in further detail throughout the specification.

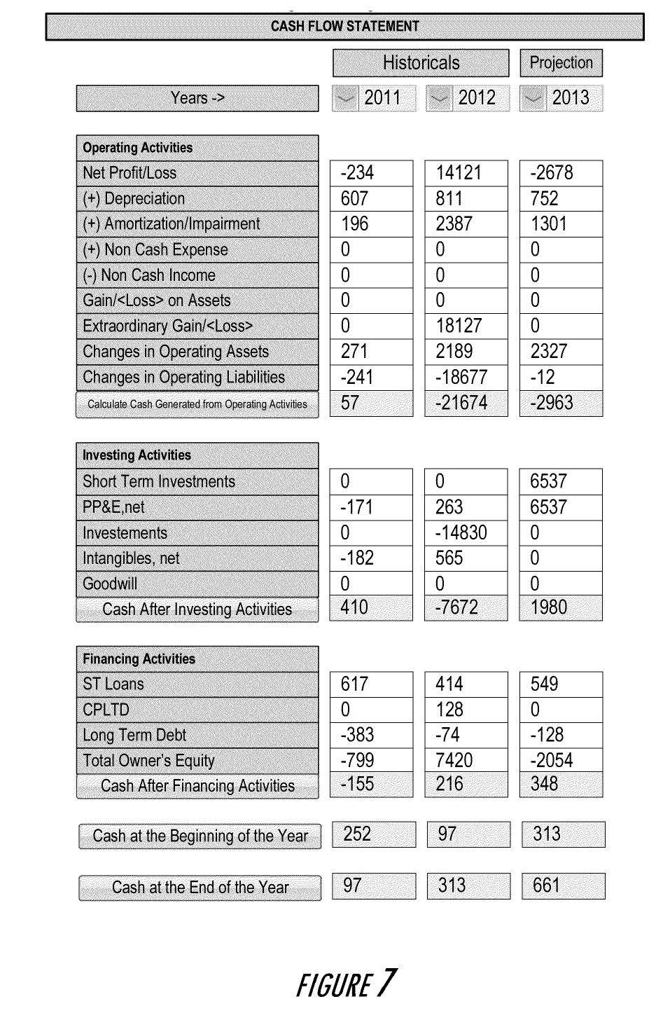

As shown in FIG. 7, the financial data parameters received and projected for a cash flow statement may include, but not be limited to, operating activities data (e.g. net profit/loss, (+) depreciation, (+) amortization/impairment, (+) non-cash expense, (−) non-cash income, gain/loss on assets, extraordinary gain/loss, changes in operating assets, changes in operating liabilities), cash generated from operating activities, investing activities data (e.g. short term investments, property, plant and equipment (PP&E) (net), investments, intangibles (net), goodwill), cash after investing activities, financing activities, loans, current portion of long-term debt (CPLTD), long term debt, total owner's equity), cash after financing activities, cash at the beginning of the year, cash at the end of the year, and the like which may be described in further detail throughout the specification.

In some embodiments the system may have predetermined definitions for the type of data that may be used in calculating and/or forecasting financial statements. As such the information may or may not be received during a retrieval step based on its availability, and some parameter related fields within the tool may or may not be populated with retrieved information where the number of fields within the tool is a static number based on the predefined definition. For example, as shown in FIG. 2, the system may define a static number of parameter used to calculate the operating expenses such as the ten (10) parameters listed; however, the system may only receive data for four (4) of the parameters allowing the other parameters to be left empty or equated to zero (0) as illustrated. In other embodiments, the system may receive any information that is available for use in calculating and/or forecasting financial statements. To this extent, each field within the tool may be populated with financial data parameters where the number of fields within the tool may vary based on the amount of information available for retrieval. For example, in alternative to the previous example, the system may only receive the four (4) data parameters that were available for analysis and exclude the other six (6) operating expenses from the customized tool or spreadsheet.

After the financial data associated with an entity requesting to receive projected and/or forecasted financial statements is received at step 110, the system may analyze the received financial data for a predetermined period of time in the past 120. To this extent the system may receive more information that what is required for analysis and only analyze selected data that is data within the predetermined period of time.

In one embodiment, analyzing the financial data further comprises determining one or more trends within the financial data for the predetermined period of time in either the past or the future. In such an embodiment, the system may first categorize and/or aggregate the financial data into subgroups and determine/detect a trend that exists in between the subgroups. For example, as illustrated in FIG. 2, the financial data may be categorized into three subgroups (e.g. 2010, 2011, 2012) based on the historical year that the financial data is associated with, and the system may then determine that each year an individual line item, or financial parameter, such as the gross profit increases with respect to a linear regression or progression.

After the financial data has been analyzed at step 120, the system may proceed to determine a financial forecast for the business entity for a predetermined period of time in the future 130. In an exemplary embodiment the financial forecast is based at least partially on the analysis of the financial data associated with the business entity in a predetermined period of time in the past.

In one embodiment, determining a financial forecast for the business entity may further comprise determining a projection scenario to be applied to the forecast or for use in providing a projected financial statement for the business entity, where the projection scenario is embodied by a specific parameter or variable. As used herein the phrases “projection variable”, “projection parameter”, and/or “projection scenario” may be used interchangeably. In such an embodiment, the system may either automatically determine the projection parameter to be applied to the forecast based at least partially on a trend within the historical financial data or receive a selection/input from a system user that identities the projection scenario to be applied to the forecast. For example, in an embodiment where the system receives a selection/input from a system user that identifies the projection scenario to be applied to the forecast, the system may first present a drop down menu within a customized tool or spreadsheet for receiving and projecting financial data. The drop down menu may contain one or more selectable options to be applied as a parameter for use in providing forecasted financial information for a predetermined period of time in the future (e.g. twelve (12) months).

The selectable options may include, but not be limited to, asset turnover, sales growth, industry correlation, linear regression, last year value, average actually numbers, average ratio, customized, and the like. For example, a system user and/or the system itself may individually determine a financial projection/forecast for each of the line items such that the projected values are subsequently presented on a forecasted financial statement. The system user may refer to the historical financial data for each of the line item, analyze each line item, and then subsequently determine a variable/parameter from the drop down menu which will be used to formulate the projections. Thus the system user may be able to view various scenarios that an analyst could be apply towards using linear regression as a parameter to forecast the financial data for the next 12 months, and various other scenarios where an analyst may use average margins as a reference point or parameter to forecast the financial data for the next 12 months.

The selection of specific parameters may vary for each line item based on an individual analysis of the financial data for each line item, and more specifically trends detected during the analysis or general financial circumstances. For example, if the business entity is a start-up company the expenses and/or income of the business entity may increase or decrease on an incremental basis such that linear regression is selected as a projection variable based on similar trends detected in the historical financial data or financial scenarios involving start-up companies. In an alternate example, if the business entity is a mature company the profits and/or expenses may be in a controlled phase such that average margin is selected as a projection variable based on similar trends detected in the historical financial data or financial scenarios involving established companies. In this way, the selection of projection variable may be determined based at least partially on an analysis of the nature of the business, the age of the business and various other factors.

In another example, if the business entity is a business that sells a tangible product, the business may have large investments into the line of the business that subsequently result in the business entity having a large asset size. In such an embodiment, if the business entity or their associated industries are at a mature stage asset turnover may be selected as a ratio and/or parameter to forecast the projections for the next twelve (12) months. In another example if the business entity is a part of an industry with very low fragmentation and a high concentration of revenues among its distinguished competitors, industry correlation may be selected as parameter to forecast the revenues. In another example, if the business entity requesting a projected statement is a company that is in a mature stage, sales quota may be selected as a parameter to forecast the projections for the next twelve (12) months.

In some embodiments, the selectable projection variables within the drop down menu may vary based upon the corresponding line item. As such the variables may be predetermined by either the system, the business entity, user input, and/or a combination of the aforementioned based upon one or more business rules, business standards, and/or user preferences. In a specific embodiment, the selectable projection variable and/or parameter is a customized parameter based on the user and/or system input. For example, if through an analysis or retrieval of the financial data of the business entity or through a portion of publicly available information it is determined that the business entity might acquire another company or divesture one of its segments, the customized field may be selected such that a system user may specify that they want to increase the revenue by a predetermined percentage or decrease the revenue by a predetermined percentage. In some embodiments, the predetermined percentage is specified via user input into the customized percentage column and/or field such that the inputted value corresponds to the adjacent line item.

In a specific example, as illustrated in FIG. 2 and FIG. 5, a specific selectable projection variable within the drop down menu is labeled “customized”. Either a system user (e.g. an analyst) or the system itself may determine that the company may acquire another entity and/or may be involved in a divesture of one of its sub-entities such that the other parameters listed within the drop down menu may not be able to accurately forecast information for the particular company. In this case, a system user may manually input percentages that reflect or indicate the percentages of the revenue that may increase or decrease within the next twelve (12) months or another predetermined period of time. As such whenever the option of customized is selected within the drop down menu, the corresponding customized percentage columns may become active such that the user is able to input a potential percentage increase and/or decrease to for use in later projecting the values within the forecasted statements. Alternatively, is the option of customized is not selected within the drop down menu, the corresponding customized percentage columns may become non-active such that they are inaccessible by a system user and cannot receive manual input.

In another example, as illustrated in FIG. 2 and FIG. 5, a specific selectable projection variable within the drop down menu is labeled “customized figure”. This option may be selected in instances where the corresponding line item cannot be projected using traditional mechanisms. For example, when the corresponding line item is a value such as impairment of goodwill which is a value that is internal to the business. In such an embodiment, the goodwill of a company may be tested for impairment at the start of the fiscal year and if the company or the business entity determines that particular benefits that they may potentially gain from the goodwill of the company may cease to exist they may select to impair those benefits for the projected year. To this extent, in such an embodiment, the value is not based on a specific formula but may be instead derived from a user input based on the internal judgment of the company. In some embodiments, the value may be selected independent of user input such that the system may simulate the internal judgment of the company or business entity based on an analysis of received notes or general data of the company such as the revenue trend of the company.

As further illustrated in FIG. 2, the customized tool or spreadsheet for receiving and projecting financial data may additionally comprise a projected year column. In such an embodiment, the system may be further configured to project and/or forecast high level information about what we can expected from the business entity if they continue conducting business according to similar trends that have previously been detected. As such the system may be configured to receive a year and/or a date, that exceeds the historical years used in the analysis (e.g. 2010-2012) and exceeds the projected year used in the forecasted statement (e.g. 2013) by a predetermined number (e.g. two (2) years). Thus is information if high level information is additionally needed for future years such as 2015 or 2016 a user may input a value into the projected year column such as the year/fiscal year and receive key projection in varying forms including, but not limited to, max sales, gross profit, operating profit, net profit, and the like.

As previously discussed, in some embodiments, the received financial data may not be specifically related to the business entity but may instead be general financial data associated with the business industry that the entity is a part of, as such industry correlation may be selected as a projection variable and/or parameter from within the drop down menu. As such the system may be configured to determine projections based at least partially on the historical figures of the particular industry and/or the projected figures for the particular industry. In one embodiment, the system may determine whether or not to use industry correlation as a projection variable based at least partially on the accuracy of the industry correlation. In such an embodiment, the system may compute the industry correlation, and the computer value is above a predetermined threshold the system may be configured to automatically select industry correlation as the projection variable. For example, if the industry correlation computed is 0.9 and the predetermined threshold is 0.7, the system may automatically select industry correlation as the projection variable.

In one embodiment, determining a financial forecast for the business entity may further comprise aligning one or more formulas, within the customized tool or spreadsheet for receiving and projecting financial data, to the projected year or “projections” column. For example, as illustrated in FIG. 2, various formulas have been aligned to the projections 2013 column based at least partially on the financial data within the historical(s) 2010, 2011, and 2012 columns. In contrast, the projected year 2015 column provides high level information about the projections for any of the future years based on whether or not the trends of the business entity continue to exist over a long period of time.

The system may be configured to receive, as a subset of the received financial data, historical figures and/or values for a plurality of line items within the income statement and balance sheet line items such that it may project one or more of the income statement line items. Descriptions of line item level projections of each income statement line item may be discussed below, herein, wherein the line item may correspond with a figure/value that maybe placed within a corresponding cell of the line item within the customized tool or spreadsheet.

In one embodiment, one or more options and/or financial parameters may be used to project a figure/value such as sales. As used herein, the phrase “net sales” may refer to an aggregate value of the sales. Revenue such as net sales is an important component used in forecasting a financial statement as it may be used as a catalyst for the projection of other line item values within the income statement and balance sheet. The system may either predefine or receive a definition of appropriate parameters for use in projecting the figure of sales. In an exemplary embodiment, parameters available for used in projecting the figure of sales may include, but not be limited to, asset turnover, sales growth, industry correlation, linear regression, and/or one or more customized options. In some embodiments the system may receive one or more financial data parameters and calculate a second financial data parameter for use in providing a projected financial statement. For example, the system may receive primary financial data parameters such as the asset turnover, sales growth, industry correlation, and linear regression of a business industry during a historical period and subsequently calculate a secondary financial data parameter such as the net sales of the business industry during the historical period, wherein the net sales is equivalent to the sum of the primary financial data parameters received or another combination of a subset of the primary financial data parameters received.

The asset turnover parameter may be used, for example, within the manufacturing business industry as it is important to know how efficiently the assets of a business have been used to historically generate the revenue. As such, the system may first determine that the business entity is performing in a mature stage of operation as the asset turnover parameter should not be used in analysis for business entities that are not in a mature stage of operation. In an exemplary embodiment the following formula may be used by the system in determining the projected asset turnover:

$$Average of ( \frac{Sales}{Assets Ratio} ) over a predetermined number of historical periods * Assets as of the most recent historical year end$$

The sales growth parameter may be used, for example, for service section business entities that are operating in a mature stage of operation. As such, the system may first determine that the business entity is performing in a mature stage of operation as the sales growth parameter should not be used in analysis for business entities that are not in a mature stage of operation. In an exemplary embodiment the following formula may be used by the system in determining the projected sales growth:

(Average of Sales over a predetermined number of historical periods*Sales for the most recent historical annual period)+Sales for the most recent historical annual period

The industry correlation parameter may be used, for example, where the majority of the industry revenue is concentrated amongst a few distinguished competitors and thus the movement in industry revenue is directly proportional to the movement in the sales of the distinguished competitors. In an exemplary embodiments, if the industry correlation of the business entity is greater than 0.90 (90%), then this parameter is preferably chosen as opposed to others. Historical correlation may be computed by comparing the revenue of the business industry with the total revenue of the entire industry. In an exemplary embodiment the following formula may be used by the system in determining the projected industry correlation:

$$\frac{revenue of the business entity}{\begin{matrix}revenue of the business industry in \\ the most recent historical annual period\end{matrix} } * revenue of the industry in the forecasted period$$

The linear regression parameter may be used, for example, may be used for business entities that are not in a mature stage of operation (e.g. newly setup/start-up companies) or are in a declining stage of operation as the movement (both increase/decline) is incremental in nature and the formula may draw a line and determine where the next data point should be placed. In some embodiments, the formula may be based at least partially on a traditional function that exists within a spreadsheet software tool. In an exemplary embodiment the following formula a forecast function (e.g. FORECAST (variable A, variable B, variable C) may be used by the system in determining the projected linear regression, where variable A is equivalent to cell reference of the forecasted year, variable B is equivalent to the cell reference of a predetermined number of historical periods, and variable C is equivalents to the cell references of the historical period in years). In another embodiment the following formula may be used by the system in determining the projected linear regression, where x and y are the sample means of the historical period in years (x, variable C) and the predetermined number of historical periods (y, variable b):

$$a + bx , where a = \overline{y} - b \overline{x} , and b = \frac{\sum ( x - \overline{x )} ( y - \overline{y )}}{\sum ( x - {\overline{x )}}^{2}}$$

The customized option parameter may be used, for example, may be used in instances where notes have been provided for a specific account and/or it may be determined based on other information that the revenue of the business industry may increase/decrease by a certain percentage either due to acquisition, divestures or increase, decrease in spend by the bank on the business entity, and the like. In an exemplary embodiment, as previously mentioned, the “customized” option may be chosen from a drop down menu such that a year may specify a percentage (positive in case of projected increase and negative in case of a projected decline) and the specified percentage may be multiplied by the value of the most recent historical period and the result may subsequently be added to the value of the most recent historical period such that a final value may be yielded for use in projecting the customized parameter.

In one embodiment, one or more options and/or financial parameters may be used to project a figure/value such as cost of goods sales (COGS). The system may either predefine or receive a definition of appropriate parameters for use in projecting the figure of cost of goods sales. In an exemplary embodiment, parameters available for used in projecting the figure of cost of goods sales may include, but not be limited to, average margins, linear regression margins, last year margins, and/or one or more customized options as previously discussed herein.

The average margins parameter may be used, for example, in cases in which high level of fluctuation have been observed in movement of the expenses. In an exemplary embodiment the following formula may be used by the system in determining the projected average margins:

$$( \frac{Average of Expenses}{Sales for a predetermined period in the past} ) * Sales of the forecasted year$$

The linear regression margins parameter may be used, for example, in cases in which the business entity are not in a mature stage of operation (e.g. newly setup/start-up companies) or are in a declining stage of operation. In an exemplary embodiment the following formula may be used by the system in determining the projected average margins:

$$\frac{expenses}{sales} - Linear Regression ,$$

where the linear regression is computed based on the prior formula/methods discussed herein.

The last year margins parameter may be used, for example, in cases in which the business entity is in a mature stage of operation. In an exemplary embodiment the following formula may be used by the system in determining the projected average margins:

$$( \frac{Most recent historical years expenses}{Sales} ) * Sales of the forecasted year$$

In one embodiment, one or more options and/or financial parameters may be used to project a figure/value such as operating expenses. The operating expenses may include, but not be limited to, selling, general and administrative expense (SG & A Expense), operating income, officers' compensation, wages & salaries, research and development, and the like. The system may either predefine or receive a definition of appropriate parameters for use in projecting the figure of operating expenses. In an exemplary embodiment, parameters available for used in projecting the figure of operating expenses may include, but not be limited to, average margins, linear regression margins, last year margins, and/or one or more customized options, where the parameter values may be computed using formulas and/or methods previously discussed herein.

In one embodiment, one or more options and/or financial parameters may be used to project a figure/value such as lease expense. The system may either predefine or receive a definition of appropriate parameters for use in projecting the figure of lease expense. In an exemplary embodiment, parameters available for used in projecting the figure of lease expense may include, but not be limited to, average margins, linear regression margins, last year value, and/or one or more customized options as previously discussed herein. The last year value parameter may be used, for example, in cases in which the business entity is operating within a mature stage of operation. In an exemplary embodiment the most recent historical year's value is reflected at the last year parameter value.

In one embodiment, one or more options and/or financial parameters may be used to project a figure/value such as depreciation. The system may either predefine or receive a definition of appropriate parameters for use in projecting the figure of depreciation. In an exemplary embodiment, parameters available for used in projecting the figure of depreciation may include, but not be limited to, average rate, linear regression rate, last year rate, and/or one or more customized options as previously discussed herein.

The average rate parameter may be used, for example, in cases in which high levels of fluctuation have been observed in the movement of expenses. In an exemplary embodiment the following formula may be used by the system in determining the projected average rate for depreciation values:

$$\frac{average of amortization}{gross intangible assets} * Gross Intangible Assets of the forecasted year$$

The linear regression rate parameter may be used, for example, in cases in which the business entity are not in a mature stage of operation (e.g. newly setup/start-up companies) or are in a declining stage of operation. In an exemplary embodiment the following formula may be used by the system in determining the projected average margins for depreciation values:

$$\frac{amortization}{gross intangible assets for all years} - Linear Regression ,$$

where the linear regression is computed based on the prior formula/methods discussed herein.

The last year rate parameter may be used, for example, in cases in which the business entity is operating within a mature stage of operation. In an exemplary embodiment the most recent historical year's rate is reflected at the last year parameter value.

In one embodiment, one or more options and/or financial parameters may be used to project a figure/value such as amortization. The system may either predefine or receive a definition of appropriate parameters for use in projecting the figure of amortization. In an exemplary embodiment, parameters available for used in projecting the figure of amortization may include, but not be limited to, average rate, linear regression rate, last year rate, and/or one or more customized options as previously discussed herein with respect to depreciation.

In one embodiment, one or more options and/or financial parameters may be used to project a figure/value such as interest income. The system may either predefine or receive a definition of appropriate parameters for use in projecting the figure of interest income. In an exemplary embodiment, parameters available for used in projecting the figure of interest income may include, but not be limited to, average rate, linear regression rate, last year rate, and/or one or more customized options as previously discussed herein.

The average rate parameter may be used, for example, in cases in which high levels of fluctuation have been observed in the movement of expenses. In an exemplary embodiment the following formula may be used by the system in determining the projected average rate for an interest income:

$$\frac{average of interest income}{( marketable securities + investments )} * ( marketable securities + investments ) of the forecasted year$$

The linear regression rate parameter may be used, for example, in cases in which the business entity are not in a mature stage of operation (e.g. newly setup/start-up companies) or are in a declining stage of operation. In an exemplary embodiment the following formula may be used by the system in determining the linear regression rate for an interest income:

$$\frac{interest income}{( marketable securities + investments ) for all years} - Linear Regression ,$$

where the linear regression is computed based on the prior formula/methods discussed herein.

In one embodiment, one or more options and/or financial parameters may be used to project a figure/value such as interest expense. The system may either predefine or receive a definition of appropriate parameters for use in projecting the figure of interest expense. In an exemplary embodiment, parameters available for used in projecting the figure of interest expense may include, but not be limited to, average margins, linear regression rate, last year rate, and/or one or more customized options as previously discussed herein.

The average rate parameter may be used, for example, in cases in which high levels of fluctuation have been observed in the movement of expenses. In an exemplary embodiment the following formula may be used by the system in determining the projected average rate for an interest expense:

$$\frac{average of interest expense}{( \begin{matrix}short term debt + \\ current portion of long term debt + \\ long term debt\end{matrix} )} * ( short term debt + current portion of long term debt + long term debt + marketable securities + investments ) of the forecasted year$$

The linear regression rate parameter may be used, for example, in cases in which the business entity are not in a mature stage of operation (e.g. newly setup/start-up companies) or are in a declining stage of operation. In an exemplary embodiment the following formula may be used by the system in determining the linear regression rate for an interest expense:

$$\frac{interest expense}{( \begin{matrix}short term debt + \\ current portion of long term debt + \\ long term debt\end{matrix} ) for all years} - Linear Regression ,$$

where the linear regression is computed based on the prior formula/methods discussed herein.

In one embodiment, one or more options and/or financial parameters may be used to project figures/values such as non-cash income, non-cash expense, other income, other expense, after tax income, after tax loss, and/or minority interest (+/−). The system may either predefine or receive a definition of appropriate parameters for use in projecting the figures non-cash expense, other income, other expense, after tax income, after tax loss, and/or minority interest (+/−). In an exemplary embodiment, parameters available for used in projecting the figures of non-cash expense, other income, other expense, after tax income, after tax loss, and/or minority interest (+/−) may include, but not be limited to, average margins, linear regression margins, last year margins, and/or one or more customized options as previously discussed herein.

The average margins parameter may be used, for example, in cases in which high level of fluctuation have been observed in movement of the expenses. In an exemplary embodiment the following formula may be used by the system in determining the projected average margins:

$$( \frac{Average of Expenses or Income}{Sales for a predetermined period in the past} ) * Sales of the forecasted year$$

The linear regression margins parameter may be used, for example, in cases in which the business entity are not in a mature stage of operation (e.g. newly setup/start-up companies) or are in a declining stage of operation. In an exemplary embodiment the following formula may be used by the system in determining the projected average margins:

$$\frac{expenses or income}{sales for all years} - Linear Regression ,$$

where the linear regression is computed based on the prior formula/methods discussed herein.

The last year margins parameter may be used, for example, in cases in which the business entity is in a mature stage of operation. In an exemplary embodiment the following formula may be used by the system in determining the projected average margins:

$$( \frac{Most recent historical years expenses or income}{Sales} ) * Sales of the forecasted year$$

In one embodiment, one or more options and/or financial parameters may be used to project a figure/value such as income/loss from subsidiaries. The system may either predefine or receive a definition of appropriate parameters for use in projecting the figures income/loss from subsidiaries. In an exemplary embodiment, parameters available for used in projecting the figure of income/loss from subsidiaries may include, but not be limited to, average, linear regression, last year, and/or one or more customized options as previously discussed herein.

The average parameter may be used, for example, in cases in which high level of fluctuation have been observed in movement of the expenses. In an exemplary embodiment the following formula may be used by the system in determining the projected average margins:

Average of figures for a predetermined period of time in the past*Sales of the forecasted year

In an exemplary embodiment, the one or more available options and/or financial parameters cannot be used to project values such as impairment of goodwill, gain or loss on assets, extraordinary gain or losses, contributions (+), and/or other adjustments to equity. To this extent parameters such as impairment of goodwill, gain or loss on assets, extraordinary gain or losses, contributions (+), and/or other adjustments to equity may require additional user input that reflects a judgment call being made by an analyst to aid in the projection and/or forecast of the figures.

In one embodiment, one or more options and/or financial parameters may be used to project a figure such as income tax/credit. The system may either predefine or receive a definition of appropriate parameters for use in projecting the figure of income tax/credit. In an exemplary embodiment, parameters available for used in projecting the figure of income tax/credit may include, but not be limited to, average tax rate, linear regression tax rate, last year tax rate, rate at thirty-five percent, and/or one or more customized options as previously discussed herein.

The average tax rate parameter may be used, for example, in cases in which high level of fluctuation have been observed in movement of the expenses. In an exemplary embodiment the following formula may be used by the system in determining the projected average margins:

average of figures for a predetermined period of time in the past*Normalized pro fit before tax of the forecasted year

The linear regression tax rate parameter may be used, for example, in cases in which the business entity are not in a mature stage of operation (e.g. newly setup/start-up companies) or are in a declining stage of operation. In an exemplary embodiment the linear regression tax rate parameter may be computed based on the linear regression trend, where the linear regression is computed based on the prior formula/methods discussed herein.

The last year tax rate parameter may be used, for example, in cases in which the business entity is in a mature stage of operation. In an exemplary embodiment the most recent historical year's tax rate may be reflected as the last year tax rate parameter value. The rate at thirty-five percent parameter may be used, for example, in cases in which the effective tax rate cannot be ascertained such that a flat rate of thirty-five percent (35%) is alternatively applied as the effective tax rate.

In one embodiment, one or more options and/or financial parameters may be used to project a figure such as dividends. The system may either predefine or receive a definition of appropriate parameters for use in projecting the figure of dividends. In an exemplary embodiment, parameters available for used in projecting the figure of dividends may include, but not be limited to, average payout rate, linear regression payout rate, last year payout rate, and/or one or more customized options as previously discussed herein.

The average payout rate parameter may be used, for example, in cases in which high level of fluctuation have been observed in movement of the expenses. In an exemplary embodiment the following formula may be used by the system in determining the projected average margins:

$$\frac{average of dividends}{\begin{matrix}net profit after tax values for a \\ predetermined period of time in the past\end{matrix}} * net profit after tax of the forecasted year$$

The linear regression payout rate parameter may be used, for example, in cases in which the business entity are not in a mature stage of operation (e.g. newly setup/start-up companies) or are in a declining stage of operation. In an exemplary embodiment the linear regression payout rate parameter may be computed based on the linear regression trend, where the linear regression is computed based on the prior formula/methods discussed herein.

The last year payout rate parameter may be used, for example, in cases in which the business entity is in a mature stage of operation. In an exemplary embodiment the most recent historical year's payout rate may be reflected as the last year payout rate parameter value.

The system may be configured to receive, as a subset of the received financial data, historical figures and/or values for a plurality of line items within the income statement and balance sheet line items such that it may project one or more of the balance sheet line items. Descriptions of line item level projections of each balance sheet line item may be discussed below, herein, wherein the line item may correspond with a figure/value that maybe placed within a corresponding cell of the line item within the customized tool or spreadsheet.

In one embodiment, one or more options and/or financial parameters may be used to project a figure/value such as the cash/cash balance. Though in exemplary embodiments, the cash balance may be used as a balancing figure that does not need to be projected. If the value is determined to be negative, the system may further determine that the business entity may need external financing to manage its operating expenses.

In one embodiment, one or more options and/or financial parameters may be used to project a figure/value such as investments/marketable securities. The system may either predefine or receive a definition of appropriate parameters for use in projecting the figures investments/marketable securities. In an exemplary embodiment, parameters available for used in projecting the figure of investments/marketable securities may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

Average of figures for a predetermined period of time in the past*Sales of the forecasted year

In one embodiment, one or more options and/or financial parameters may be used to project a figure/value such as net accounts receivable. The system may either predefine or receive a definition of appropriate parameters for use in projecting the figures net accounts receivable. In an exemplary embodiment, parameters available for used in projecting the figure of net accounts receivable may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

$$average ( \frac{average of receivables}{Sale for a predetermined period of time in the past * 365} ) * Sales of the forecasted year$$

In one embodiment, one or more options and/or financial parameters may be used to project a figure/value such as inventory. The system may either predefine or receive a definition of appropriate parameters for use in projecting the figure of inventory. In an exemplary embodiment, parameters available for used in projecting the figure of inventory may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

$$average ( \frac{average of inventory}{cost of goods sales * 365} ) * Sales of the forecasted year$$

In one embodiment, one or more options and/or financial parameters may be used to project a figure/value such as cost in excess of billings. The system may either predefine or receive a definition of appropriate parameters for use in projecting the figure of cost in excess of billings. In an exemplary embodiment, parameters available for used in projecting the figure of cost in excess of billings may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

$$average ( \frac{average of cost in excess of billings}{\begin{matrix}operating expenses for a predetermined \\ period of time in the past * 365\end{matrix} } ) * Sales of the forecasted year$$

In one embodiment, one or more options and/or financial parameters may be used to project a figure/value such as other current assets. The system may either predefine or receive a definition of appropriate parameters for use in projecting the figure of other current assets. In an exemplary embodiment, parameters available for used in projecting the figure of other current assets may include, but not be limited to, average actual numbers, average ratio (other current assets/total assets), linear regression ratio (other current assets/total assets) and/or one or more customized options as previously discussed herein. The average actual numbers parameters may be used in cases where other current assets are not falling in direct relationship with any other parameter as such use of this parameter may be normally seen in scenarios that involve service sector business entities. The average ratio parameter may be used in scenarios involving business entities that operate in the manufacturing business industry sector.

In one embodiment, one or more options and/or financial parameters may be used to project a figure/value such as net property, plant, and equipment. The system may either predefine or receive a definition of appropriate parameters for use in projecting the figure of property, plant, and equipment. In an exemplary embodiment, parameters available for used in projecting the figure of other property, plant, and equipment may include, but not be limited to, last year balance (−) depreciation and/or one or more customized figures as previously discussed herein. The last year balance depreciation parameter may be used, for example, in instances when no fixed asset has been purchased or sold within a respective year. The customized parameter may be used when a fixed asset has been purchased with the respective year.

In one embodiment, one or more options and/or financial parameters may be used to project a figure/value such as intangibles. The system may either predefine or receive a definition of appropriate parameters for use in projecting the figure of intangibles. In an exemplary embodiment, parameters available for used in projecting the figure of other intangibles may include, but not be limited to, last year balance (−) amortization and/or one or more customized figures as previously discussed herein. The last year balance amortization parameter may be used, for example, in instances when no intangible asset has been recognized within a respective year. The customized parameter may be used when an intangible asset has been recognized with the respective year.

In one embodiment, one or more options and/or financial parameters may be used to project a figure such as investments. The system may either predefine or receive a definition of appropriate parameters for use in projecting the figure of investments. In an exemplary embodiment, parameters available for used in projecting the figure of investments may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

average of figures for a predetermined period of time in the past

In one embodiment, one or more options and/or financial parameters may be used to project a figure/value such as goodwill. The system may either predefine or receive a definition of appropriate parameters for use in projecting the figure of goodwill. In an exemplary embodiment, parameters available for used in projecting the figure of other goodwill may include, but not be limited to, last year figure, last year figure (−) impairment, and/or one or more customized options as previously discussed herein. The last year balance depreciation parameter may be used, for example, in instances when no fixed asset has been purchased or sold within a respective year. The customized parameter may be used when a fixed asset has been purchased with the respective year.

In one embodiment, one or more options and/or financial parameters may be used to project a figure/value such as deferred income taxes. The system may either predefine or receive a definition of appropriate parameters for use in projecting the figure of deferred income taxes. In an exemplary embodiment, parameters available for used in projecting the figure of deferred income taxes may include, but not be limited to, average actual numbers, average ratio (deferred income taxes/total assets), linear regression (deferred income taxes/total assets) and/or one or more customized figures as previously discussed herein with reference to other current assets. In such an embodiment, the customized figure parameter may be used at the discretion of a system user and/or based on a determination made during analysis by the system.

In one embodiment, one or more options and/or financial parameters may be used to project a figure/value such as other long term assets. The system may either predefine or receive a definition of appropriate parameters for use in projecting the figure of other long term assets. In an exemplary embodiment, parameters available for used in projecting the figure of other long term assets may include, but not be limited to, average actual numbers, average ratio (long term assets/total assets), linear regression (long term assets/total assets) and/or one or more customized figures as previously discussed herein with reference to other current assets. In such an embodiment, the customized figure parameter may be used at the discretion of a system user and/or based on a determination made during analysis by the system.

In one embodiment, one or more options and/or financial parameters may be used to project a figure/value such as loans. The system may either predefine or receive a definition of appropriate parameters for use in projecting the figure of loans. In an exemplary embodiment, parameters available for used in projecting the figure of loans may include, but not be limited to, average, linear regression, last year, and/or one or more customized options as previously discussed herein with references to income/loss from subsidiaries. In such an embodiment, the customized figure parameter may be used at the discretion of a system user and/or based on a determination made during analysis by the system.

In one embodiment, one or more options and/or financial parameters may be used to project a figure/value such as current portion of long-term debt. The system may either predefine or receive a definition of appropriate parameters for use in projecting the figure of current portion of long-term debt. In an exemplary embodiment, parameters available for used in projecting the figure of current portion of long-term debt may include, but not be limited to, last year value, and/or one or more customized options as previously discussed herein with references to income/loss from subsidiaries. In such an embodiment, the customized figure parameter may be used at the discretion of a system user and/or based on a determination made during analysis by the system. The last year value may be used, for example, in instances when no additional debt is expected to be taken through the respective year. Likewise, in one embodiment, one or more options and/or financial parameters may be used to project a figure/value such as long-term debt. The system may either predefine or receive a definition of appropriate parameters for use in projecting the figure of long-term debt. In an exemplary embodiment, parameters available for used in projecting the figure of long-term debt may include, but not be limited to, subtracting the current portion of long term debt value from the long term debt, and/or one or more customized options as previously discussed herein with references to income/loss from subsidiaries.

In one embodiment, one or more options and/or financial parameters may be used to project a figure/value such as billings in excess of cost. The system may either predefine or receive a definition of appropriate parameters for use in projecting the figure billings in excess of cost. In an exemplary embodiment, parameters available for used in projecting the figure of billings in excess of cost may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

$$average ( \frac{average of billings in excess of costs}{\begin{matrix}operating expenses for a predetermined \\ period of time in the past * 365\end{matrix} } ) * Sales of the forecasted year$$

In one embodiment, one or more options and/or financial parameters may be used to project a figure/value such as accounts payable. The system may either predefine or receive a definition of appropriate parameters for use in projecting the figure accounts payable. In an exemplary embodiment, parameters available for used in projecting the figure accounts payable may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

$$average ( \frac{average of payables}{\begin{matrix}operating expenses for a predetermined \\ period of time in the past * 365\end{matrix} } ) * Sales of the forecasted year$$

In one embodiment, one or more options and/or financial parameters may be used to project a figure/value such as accrued liabilities. The system may either predefine or receive a definition of appropriate parameters for use in projecting the figure accrued liabilities. In an exemplary embodiment, parameters available for used in projecting the figure accrued liabilities may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

$$average ( \frac{average of accrued expense}{\begin{matrix}operating expenses for a predetermined \\ period of time in the past * 365\end{matrix} } ) * Sales of the forecasted year$$

In one embodiment, one or more options and/or financial parameters may be used to project a figure/value such as other current liabilities. The system may either predefine or receive a definition of appropriate parameters for use in projecting the figure other current liabilities. In an exemplary embodiment, parameters available for used in projecting the figure of other current liabilities may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

$$average ( \frac{average of other current liabilities}{\begin{matrix}operating expenses for a predetermined \\ period of time in the past * 365\end{matrix} } ) * Sales of the forecasted year$$

In one embodiment, one or more options and/or financial parameters may be used to project a figure/value such as deferred revenue. The system may either predefine or receive a definition of appropriate parameters for use in projecting the figure deferred revenue. In an exemplary embodiment, parameters available for used in projecting the figure of deferred revenue may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

$$average ( \frac{average of deferred revenue}{sales for a predetermined period of time in the past * 365} ) * Sales of the forecasted year$$

In one embodiment, one or more options and/or financial parameters may be used to project a figure/value such as deferred income taxes. The system may either predefine or receive a definition of appropriate parameters for use in projecting the figure deferred income taxes. In an exemplary embodiment, parameters available for used in projecting the figure of deferred income taxes may include, but not be limited to, average, linear regression, and/or one or more customized options as previously discussed herein.

The average parameter may be used, for example, in cases in which high level of fluctuation have been observed in movement of the expenses. In an exemplary embodiment the following formula may be used by the system in determining the projected average margins:

$$average ( \frac{average of deferred income taxes}{\begin{matrix}operating expenses for a predetermined \\ period of time in the past * 365\end{matrix} } ) * Sales of the forecasted year$$

In some embodiments, determining a financial forecast for the business entity may further the customized tool or spreadsheet for receiving and projecting financial data having one or more buttons that trigger the calculation of a value. For example, as illustrated in Figure—______, the tool may comprise a calculated equity button that initiates a calculation when selected. In a specific example, upon selected the calculated equity button the system may add the most recent historical year equity, and the net income (loss) of the projected year, subtract distributions, add the contributions, and add/subtract other adjustments to the equity, and present the final value within the owner's equity line item of the projections for 2013. Other calculation buttons may include, but not be limited to, “calculating the gross profit”, “calculating the total operating expenses”, “calculating the operating income”, “calculating the net profit loss”, and the like. The calculation buttons may provide auto populated figures in response to their selection.

After the determining a financial forecast for the business entity for a predetermined period of time in the future 130, the system may proceed to provide one or more projected and/or forecasted financial statements 140, as shown in the illustrated embodiments, that comprise the data rendered during the financial forecast step 130. Providing one or more projected financial statements for the predetermined period of time in the future at step 140 may further comprise determining and providing one or more recommendations to continue or discontinue a business relationship with a particular entity or business industry based at least partially on the projected financial statement. The projected financial statements may be stored in a database, transmitted via email or another form of messaging, presented within the customized tool or spreadsheet, presented with an online platform or website, and/or a combination of the aforementioned.

In some embodiments, the system is further configured to determine the accuracy of the forecasted financial statement based at least partially upon the accuracy of previously forecasted financial statements, and more specifically the financial data and market conditions during those time periods and the data's similarities and/or differences with respect to the currently forecasted data and the current market conditions. For example, if the market current market conditions are similar to previous years when the forecasted financial statement(s) for a particular year were 88% accurate to the actual outcome of that particular year, the system may determine that the currently forecasted statement may be within a range of 80-90% accurate.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for use in financial forecast systems, whereby the apparatus analyzes historical financial data for purposes of providing projected financial statements, the apparatus comprising:
a memory;
a computing processor; and
a module stored in the memory, said module comprising instruction code executable by one or more computing processors, and configured to cause the one or more computing processors to:
receive financial data that is associated with a business entity requesting to receive projected financial statements, wherein the financial data is received from a predetermined period of time in the past;
analyze the financial data from the predetermined period of time in the past;
determine a financial forecast for the business entity for a predetermined period of time in the future, wherein the financial forecast is based at least partially on the analysis of the from the predetermined period of time in the past; and
provide one or more projected financial statements for the predetermined time period in the future based at least partially on the financial forecast of the business entity.

2. The apparatus of claim 1, wherein the module is further configured to cause one or more computer processors to:
receive a request from the business entity that identifies the business entity is requesting to receive a projected financial statement, and
transmit the request to a third party entity such that the financial data associated with the business entity is received from a database maintained by the third party entity.

3. The apparatus of claim 1, wherein the financial data is automatically retrieved, from at least one database associated with the business entity, in response to receiving a request from the business entity to provide at least one projected financial statement.

4. The apparatus of claim 1, wherein the financial data is manually inputted by a user associated with the business entity requesting to receive at least one projected financial statements, and wherein the module is further configured to cause one or more computer processors to prompt the user to manually enter the financial data in response to receiving a request from the business entity to provide projected financial statements.

5. The apparatus of claim 1, wherein the financial data is received on a semi-continuous basis and periodically stored such that it is retrievable for analysis at a later time.

6. The apparatus of claim 1, wherein the module is further configured to cause one or more computer processors to determine the accuracy of a projected financial statement based at least partially upon the accuracy at least one previously projected financial statement.

7. The apparatus of claim 1, wherein the module comprises a customized tool for receiving and projecting financial data having one or more buttons that trigger the calculation of a plurality of values.

8. The apparatus of claim 1, wherein the module is further configured to cause one or more computer processors to provide a high level projected financial statement for a time period that exceeds the predetermined period of time in the future.

9. The apparatus of claim 1, wherein the module is further configured to cause one or more computer processors to determine one or more trends within the financial data for the predetermined period of time in the past.

10. The apparatus of claim 1, wherein the module is further configured to cause one or more computer processors to:
determine that a portion of the received information is useful for analysis in providing a projected financial statement; and
extract the portion of information for analysis.

11. The apparatus of claim 1, wherein the module is further configured to cause one or more computer processors to:
determine whether or not an adequate amount of information has been received to conduct an analysis that will yield and accurate projected financial statement; and
request that a user input additional information based at least partially on determining that an adequate amount of information has not been received.

12. The apparatus of claim 1, wherein the module is further configured to cause one or more computer processors to receive general financial data associated with the business industry that the business entity is a part of.

13. The apparatus of claim 1, wherein the module is further configured to cause one or more computer processors to determine the type of business industry that the business entity is a part of based on at least one of a user input, an analysis of the received information associated with the business entity, or a searching method.

14. The apparatus of claim 1, wherein the module is further configured to cause one or more computer processors to receive, from a user, a code or identifier that indicates an industry type associated with the business entity.

15. The apparatus of claim 1, wherein the module is further configured to determine a projection scenario for use in providing a projected financial statement, wherein the projection scenario is used during the analysis of the financial data.

16. The apparatus of claim 15, wherein the projection scenario is determined in response to a user input, wherein a user selects the projection scenario from within a drop down menu that list one or more selectable projection variables.

17. The apparatus of claim 1, wherein the module is further configured to cause one or more computer processors to:
receive, within the financial data, one or more primary financial data parameters having a numeric value; and
calculate a secondary financial data parameter having a numeric value for use in providing the projected financial statement.

18. A method for use in financial forecast systems, whereby the method analyzes historical financial data for purposes of providing projected financial statements, the method comprising:
receiving financial data that is associated with an entity requesting to receive projected financial statements, wherein the financial data is received from a predetermined period of time in the past;
analyzing the financial data from the predetermined period of time in the past;
determining a financial forecast for the entity for a predetermined period of time in the future, wherein the financial forecast is based at least partially on the analysis of the from the predetermined period of time in the past; and
providing one or more projected financial statements for the predetermined time period in the future based at least partially on the financial forecast of the entity.

19. The method of claim 10, the method further comprising:
receiving, within the financial data, one or more primary financial data parameters having a numeric value; and
calculating a secondary financial data parameter having a numeric value for use in providing the projected financial statement.

20. A computer program product for use in financial forecast systems, whereby the computer program product analyzes historical financial data for purposes of providing projected financial statements, the computer program product comprising:
a non-transitory computer-readable medium comprising a set of codes for causing a computer to:
receive financial data that is associated with an entity requesting to receive projected financial statements, wherein the financial data is received from a predetermined period of time in the past;
analyze the financial data from the predetermined period of time in the past;
determine a financial forecast for the entity for a predetermined period of time in the future, wherein the financial forecast is based at least partially on the analysis of the from the predetermined period of time in the past; and
provide one or more projected financial statements for the predetermined time period in the future based at least partially on the financial forecast of the entity.

21. The computer program product of claim 19, the computer program product further comprising a set of codes for causing a computer to:
receive, within the financial data, one or more primary financial data parameters having a numeric value; and
calculate a secondary financial data parameter having a numeric value for use in providing the projected financial statement.
